(19) United States
(12) Patent Application Publication
(10) Pub. No.: US 2026/0310185 A1
(43) Pub. Date: Oct. 8, 2026

(54) ENTITY IDENTIFICATION IN A MULTISTAGE ENTITY COORDINATION NETWORK

(71) Applicant: Honeywell International Inc., Charlotte, NC (US)

(72) Inventors: Ankit Singh, Apex, NC (US); Kartik Bollapalli, Bangalore (IN)

(21) Appl. No.: 19/172,666

(22) Filed: Apr. 8, 2025

(51) Int. Cl. G05B 19/418; G06F 40/295

(52) U.S. Cl. CPC G05B 19/41865; G05B 19/4185; G06F 40/295; G05B 2219/32015

(57) ABSTRACT

Techniques for identification of entities in a multistage entity coordination network are disclosed. An entity identification signal, indicating at least one of entity descriptors and resource descriptors, is received. An entity intelligence database, comprising empirical entity indicators and empirical resource indicators, is assessed. Each empirical entity indicator identifies one of the plurality of entities, and each empirical resource indicator is linked with an entity and indicates a resource attribute of that entity. A set of empirical entity indicators correlating with the entity descriptors and a set of empirical resource indicators correlating with the resource descriptors are identified. Based on these correlations, a set of entities is identified from amongst the plurality of entities that likely comply with specified resource characteristics. A multistage entity indication signal is then generated to cause rendering of the identified set of entities.

### BACKGROUND

A supply chain is typically a network composed of various entities operating at different stages. These entities can include, for example, manufacturers, distributors, storage service providers, and retailers, each with distinct yet interconnected roles. The supply chain process is typically intricate, requiring coordination among these entities and managing numerous activities related to the production and distribution of products. For example, the process spans from sourcing raw materials to delivering finished products to consumers. However, a network of entities spread across multiple stages in a supply chain introduces several challenges and complexities, for instance, in the identification of suitable or desired entities.

### BRIEF DESCRIPTION OF DRAWINGS

The detailed description is described with reference to the accompanying figures. It should be noted that the description and figures are merely examples of the present subject matter and are not meant to represent the subject matter itself.

FIGS. 1A to 1C illustrate a block diagram of a computing environment, according to an example implementation of the present subject matter.

FIG. 2 illustrates the entity intelligence database, according to one example of the present subject matter.

FIG. 3 illustrates a block diagram of a system, according to one example implementation of the present subject matter.

FIG. 4 illustrates a block diagram of a computing environment, according to one example implementation of the present subject matter.

FIG. 5 illustrates a block diagram of an interactive platform, according to one example implementation of the present subject matter.

FIG. 6 illustrates a block diagram of a graphical user interface indicating a set of entities, according to one example implementation of the present subject matter.

FIG. 7 illustrates an exemplary method for identification of one or more entities in one or more multistage entity coordination networks, according to one example implementation of the present subject matter.

FIG. 8 illustrates a non-transitory computer-readable medium for identifying a set of entities for forming an entity coordination network instance, according to one example implementation of the present subject matter.

Throughout the drawings, identical reference numbers designate similar, but not necessarily identical, elements. The figures are not necessarily scaled, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Generally, a supply chain is a network formed by multiple entities involved at different stages. Such entities may be, for example, manufacturers, distributors, storage service providers, and retailers. These entities may have distinct yet interconnected functionalities in the supply chain. For example, a supply chain may involve coordination between multiple entities and overseeing several activities related to the production and distribution of products, from sourcing raw materials to delivering final products to consumers.

However, such an intricate web of interactions presents significant challenges in managing and optimizing supply chain operations. For instance, in a complex network of entities spread across multiple stages, it may be difficult to track the performance of individual entities across different parameter requirements. Such a limitation hinders the ability to identify and select suitable entities for specific roles within the supply chain. The complexity of multi-stage supply chains further exacerbates this issue, making it challenging to develop more efficient routes and optimize the overall supply chain structure.

While technological advancements have led to the development of various solutions aimed at tracking supply chain progress and entity performance, these solutions suffer from several limitations. For instance, such solutions focus on providing insights about entities currently involved in the supply chain. This narrow scope fails to offer information and insights about other potential entities that could be advantageous or more appropriate for inclusion in the supply chain or for performing specific functionalities. As a result, there is a significant barrier to making informed decisions about optimizing the network of entities within the supply chain.

Further, such a siloed approach leads to limited visibility into the operations or performance of other entities, i.e., entities in addition to the entities already involved in the supply chain. The lack of transparency may create numerous challenges and limitations. For instance, there are substantial difficulties in selecting more suitable entities due to a lack of comprehensive data. For example, a manufacturer of a product may face difficulties in identifying and selecting more suitable partners due to the lack of comprehensive performance data. Without a holistic insight into the entire supply chain or about other entities, there is a struggle to effectively optimize resources and operations, leading to inefficiencies and missed opportunities for improvement

Furthermore, without access to comprehensive data from across the entire supply chain, entities are forced to base their strategic and operational decisions on partial or potentially obsolete information. This can lead to suboptimal choices in areas, for example, inventory management, production planning, and partner selection, ultimately impacting the overall efficiency and effectiveness of the supply chain. Also, absence of centralized information poses significant obstacles to business growth and adaptability. For instance, as companies seek to expand into new regions or product lines, the lack of comprehensive data across entities of the supply chain hinders their ability to make informed decisions and adapt quickly to changing market conditions or demands. Such a limitation can result in missed opportunities, increased risks, and reduced competitiveness in the global marketplace.

Thus, the existing limitations may be characterized as fragmented information and limited visibility that restrict comprehensive performance assessment and entity selection. These limitations significantly hinder the ability to optimize the supply chains, adapt to changing market conditions, and make data-driven decisions that could enhance overall operational efficiency and competitiveness.

The present subject matter discloses techniques for assisting identification of one or more entities within a multistage entity coordination network. In one example, the multistage entity coordination network may be a supply chain network having multiple interlinked stages and a plurality of entities. In another example, the multistage entity coordination network may include multiple supply chain networks and entities of such supply chain networks. Examples of the entities may include, but are not limited to, manufacturers, suppliers, third-party logistics providers, distributors, wholesale retailers, warehouses, and retailers.

According to one example, an entity identification signal may be received. In one example, the entity identification signal may include a query for identifying a set of entities from amongst a plurality of entities linked with the multistage entity coordination network. The entity identification signal may indicate at least one of an entity descriptor and a resource descriptor. In one example, the entity descriptor may indicate an identification characteristic about the set of entities which are to be identified. Further, the resource descriptor may indicate a resource characteristic to be complied by the set of entities. For example, the entity identification signal may include a query aiming for distributors capable of maintaining a certain temperature range, say 20 to 22 degrees Celsius. In such a query, “distributors” may serve as an entity descriptor identifying the type of entity. Further, the requirement of maintaining a certain temperature range may indicate that an entity should possess resources of appropriate characteristics or capabilities for being able to maintain that temperature range. Thus, the requirement of maintaining the temperature range may be termed as a resource characteristic required to be complied by the set of entities which are to be identified.

Further, the entity descriptor and the resource descriptor may be queried with an entity intelligence database. In one example, the entity intelligence database may be a comprehensive database comprising details of multiple supply chains and entities involved therein. The entity intelligence database may comprise a plurality of empirical resource indicators indicating resource attributes for various entities. Examples of the resource attributes may include, but are not limited to, resource specifications, performance metrics, and Key Performance Indicators (KPIs). In one example, the entity intelligence database may also comprise a plurality of empirical entity indicators that identify each of the plurality of entities. The empirical entity indicators may be, for example, names, roles, and the like, associated with each of the plurality of entities. Thus, the entity intelligence database may be a comprehensive database identifying the plurality of entities and their resource capabilities or attributes.

The entity intelligence database may be queried to determine or identify the set of entities that comply with the requirements indicated in the entity identification signal. For example, the entity intelligence database may be queried to identify a set of empirical entity indicators, from amongst the plurality of empirical entity indicators, that correlate with the entity descriptor indicated in the entity identification signal. For instance, considering the above example, empirical entity indicators semantically correlating with “distributors” may be determined. Further, for the identified empirical entity indicator, a set of empirical resource indicators correlating with the resource descriptor may be identified. For instance, considering the above example, empirical resource indicators indicating resource attributes semantically or logically amounting to the resource descriptors indicated in the entity identification signal may be identified. For example, distributors with KPI indicating performance in maintaining the required temperature range may be identified.

Using such correlating empirical entity indicators and the empirical resource indicators, a corresponding set of entities may be identified from amongst the plurality of entities in the multistage entity coordination network. A multistage entity indication signal may then be generated to cause rendering of a recommendation indicating the identified set of entities.

The present subject matter addresses problems associated with limited visibility that restricted scope of suitable entity selection. For instance, by utilizing the comprehensive entity intelligence database comprising details of multiple supply chains and entities involved therein, visibility to details about entities linked with one or more supply chains is enhanced. This comprehensive view allows access to additional insights, for instance, about the characteristics or capabilities of various entities linked with the one or more supply chains. The improved visibility may thus facilitate data-driven identification of suitable entities, which may potentially lead to more confident entity selection and can improve the efficiency of the supply chain. The use of entity intelligence database with empirical indicators supports data-driven decision-making, thereby tackling the issue of suboptimal decision-making based on partial or incomplete information. With access to comprehensive data, entities can make more informed choices that can improve overall supply chain performance.

Further, the entity intelligence database may act as a centralized database, thereby providing a standardized way to compare entity resource characteristics or capabilities. This addresses the lack of standardization, enabling more accurate benchmarking and performance evaluation across different entities and stages of the supply chain. Also, by identifying entities based on specific resource capabilities or characteristics (such as KPIs), the disclosed technique allows for optimized selection of entities with suitable resources across one or more supply chains. Such an approach may result in efficient allocation and utilization of resources across the supply chain.

Thus, the disclosed techniques provide a more integrated, transparent, and data-driven approach to supply chain management by enhancing visibility for facilitating better entity selection and could significantly improve the efficiency and effectiveness of the supply chains.

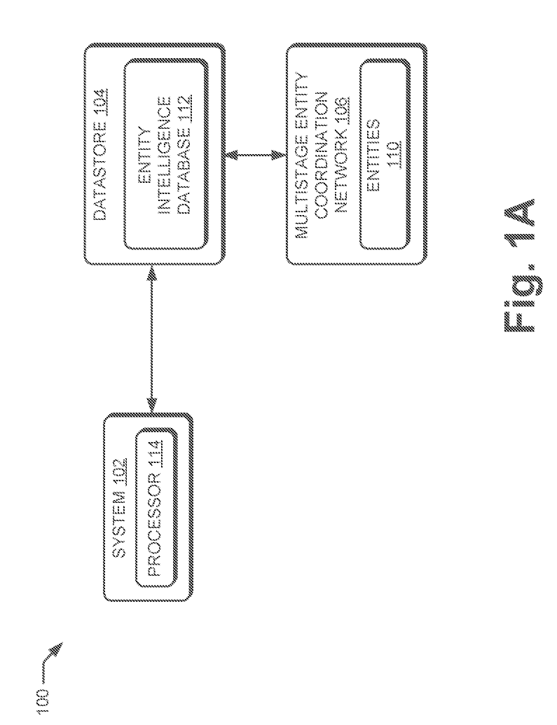

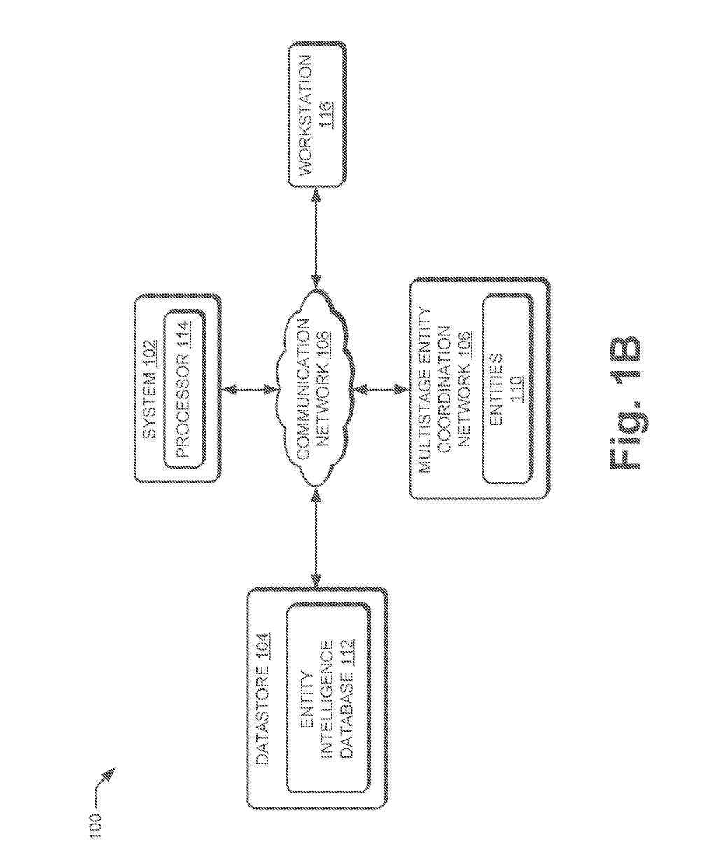

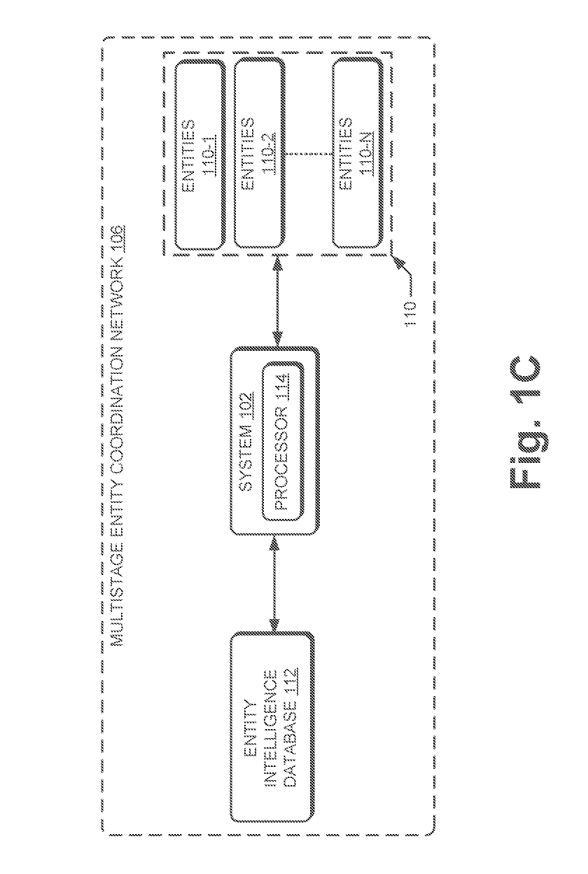

The above techniques are further described with reference to FIGS. 1A to 8. It would be noted that the description and the figures merely illustrate the principles of the present subject matter along with examples described herein and would not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIGS. 1A to 1C illustrate a block diagram of a computing environment 100, according to an example implementation of the present subject matter. FIGS. 1A to 1C will be discussed in conjunction with each other.

In one example, the computing environment 100 may comprise a system 102 communicably linked with a datastore 104. Further, at least one of the system 102 and the datastore 104 may be communicably linked with a multistage entity coordination network 106. In one example, the communicable connection may be direct, either wirelessly or through one or more wires, and may enable exchange of data and/or signals therebetween. In another example, the communicable connection may be via a communication network 108, as illustrated in FIG. 1B, to exchange data and/or signals.

The computing environment 100 may thus be a network of such one or more components that may be communicably coupled, for example, over the communication network 108 to exchange data and/or signals. Examples of the communication network 108 may include, but are not limited to LAN, WAN, the internet, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the communication network 108 may include various network entities, such as transceivers, gateways, and routers. In an example, the communication network 108 may include any communication network that uses any of the commonly used protocols, for example, Hypertext Transfer Protocol (HTTP), and Transmission Control Protocol/Internet Protocol (TCP/IP).

In one example, the multistage entity coordination network 106 may be a supply chain network. In another example, the multistage entity coordination network (MECN) 106 may be a network of multiple supply chain networks. In yet another example, a collection of multiple isolated supply chain networks may also be referred to as MECN 106. Examples of supply chain network or MECN 106 may include, but are not limited to, the automotive industry, where raw materials are transformed into car parts and assembled into vehicles; the food and beverage industry, which involves the production, processing, and distribution of food products; the pharmaceutical industry, encompassing the development, manufacturing, and distribution of medications; the fashion industry, which includes the sourcing of fabrics, production of clothing, and distribution to retailers; and the electronics industry, where components are manufactured, assembled into devices, and distributed to consumers.

Further, the MECN 106 may comprise a plurality of entities 110. For example, the MECN 106 may comprise entities 110-1, 110-2,…, and 110-N, where N is a natural number, as illustrated in FIG. 1C. The plurality of entities may hereinafter be collectively referred to as the plurality of entities 110 and individually as an entity 110. The plurality of entities 110 may be, for example, members of the supply chain network or MECN 106. Examples of the entities may include, but are not limited to, suppliers, manufacturers, distributors, third-party logistics providers, warehouses, and retailers.

In one example, the MECN 106 may comprise a plurality of interlinked stages, where each of the plurality of entities 110 may be linked with at least one of the plurality of interlinked stages. For instance, as in a supply chain network, each of the plurality of entities 110 may be sequentially interlinked based on their roles in the supply chain network. For example, in an automotive industry, the supply chain may begin with a raw material supplier (entity 110-1) who may provide essential materials like steel and aluminium. These materials may then be used by a manufacturer (entity 110-2) to produce specific car components such as engines and transmissions. The parts may then be sent to an assembly plant (entity 110-3) where they may be assembled into finished vehicles. The completed cars are stored in distribution centers (other entities 110) before being shipped to various dealerships (other entities 110).

In yet another example, the MECN 106 may be a network of plurality of entities 110 configured to manage and process data. For example, the entities 110 may be software, applications, or platforms capable of extracting, loading, and/or processing data into actionable insights. For instance, the MECN 106 may be a network of plurality of entities 110 configured to extract/obtain data from multiple sources, such as databases, clean and organize the data, load the data into a data warehouse for analysis or processing using specialized tools or software, and create dashboards or reports that visualize key insights. Similarly, other examples of the MECN 106 may also be possible where the plurality of entities 110 may be capable of performing other tasks or chain of operations.

Further, the datastore 104 may comprise, in one example, a set of storage devices capable of storing data, files, and/or information. The set of storage devices may be virtual storage devices, physical storage devices, a cloud-based storage service, or a combination thereof. For example, the datastore 104 may include any repository or storage unit implemented by physical, logical, and/or virtual storage devices. In one example, the datastore 104 may include a set of physical storage devices. In another example, the datastore 104 may include virtual storage devices being implemented on physical storage devices. In another example, the datastore 104 may include one or more physical or logical storage units that may either be located at the same location or distributed geographically. In another example, the datastore 104 may be implemented over a cloud-based storage service. Further, the datastore 104 may be a single datastore or a combination of two or more datastores.

In one example, the datastore 104 may store an entity intelligence database 112. The entity intelligence database 112 may be an organised collection of comprehensive information, or data, about the plurality of entities 110 and may be stored electronically in the datastore 104. In one example, the entity intelligence database 112 may comprise a plurality of empirical resource indicators and a plurality of empirical entity indicators. The empirical entity indicators may be any information linked with the plurality of entities 110 that may enable the identification of the entities 110. In one example, each of the plurality of entities 110 may have an empirical entity indicator linked therewith for identifying that entity 110. For example, the empirical entity indicators may indicate entity names, roles in a supply chain, location identifiers, entity identifiers, contact information, addresses, and other information that may sufficiently identify an entity in the MECN 106. For example, the empirical entity indicator may assist in identifying whether an entity is a distributor, manufacturer or other partner or entity in the MECN 106. Further, where the entities 110 may be computing devices, software, or other platforms, examples of empirical entity identifiers may indicate, for example, Internet Protocol (IP) addresses, domain names, host names, application identifiers, Media Access Control (MAC) address, Virtual Machine (VM) identifiers, digital certificates, keys, and the like.

Further, the empirical resource indicators may be any information linked with the plurality of entities 110 that may indicate any characteristic or resource attribute of that entity 110. Examples of resource attributes or characteristics may include, but are not limited to, compliance success rate indicating how well an entity 110 is trained on compliance aspects of a product or service, product lines handled by the entity 110, temperature management capabilities, infrastructure footprint (such as the number of warehouses and regions covered), experience in business, delivery turnaround time, environmental compliance indicating an entity’s adherence to environmental regulations and sustainability practices, customer satisfaction rate indicating the performance of the entity 110, cost efficiency of the entity's operations, quality control rate, reliability, production capacity, energy efficiency, scalability, flexibility, query processing rate, data storage capacity, data processing rate, hardware specifications, and network bandwidth.

In one example, the resource attributes may be indicative of capabilities, performance, and other characteristics of the entities. In one example, the resource attributes may be indicated in the form of metrics or Key Performance Indicators (KPIs). Thus, each of the plurality of entities 110 may have the resource attribute or KPI linked therewith. Further, the resource attribute may also be indicative of resources, or characteristics or capabilities of those resources, that an entity 110 may possess. For example, the resource attribute or KPI indicating that an entity may be able to maintain a certain temperature range, may indicate that an entity possesses resources (such as Heating, Ventilation, and Air Conditioning (HVAC) systems of a particular capacity) of appropriate characteristics or capabilities for being able to maintain that temperature range.

In another example, the resource attribute or KPI indicating the delivery turnaround time may be indicative of resources (such as number of transport vehicles, available modes of transportation, and the like) of appropriate characteristics or capabilities for being able to deliver products within a certain timeframe. In another example, the resource attribute or KPI may indicate an amount of data that an entity 110 is capable of storing, transmitting, and/or processing, thus being indicative of resources (such as the capacity of storage devices, processing power, and the like) of the entity 110. Thus, the resource attribute or KPI may be indicative of resource capabilities or characteristics of an entity. In yet another example, the resource attribute may be indicative of specific configuration, hardware components, or software applications possessed or associated by the entity 110.

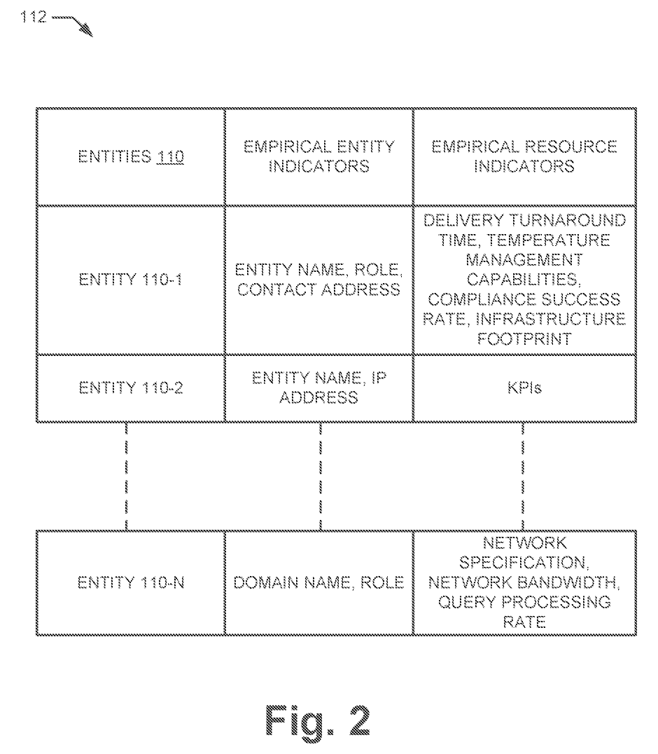

Further, the above examples are for illustration purposes and should not be considered to be limiting. The resource attributes can also be indicative of information other than or more than resource characteristics or capabilities of the entity 110. Any other information that may be indicative of performance, feature, attribute, or capability of the entity 110 can also be termed as the resource attribute. That is, the empirical resource indicators may indicate or define a wide range of information about the resources, performance, features, and capabilities of the entity 110. Each of the plurality of entities 110 may have one or more empirical entity indicators and one or more empirical resource indicators associated therewith that may provide comprehensive information about that entity 110, as illustrated in FIG. 2, according to one example.

The entity intelligence database 112 may thus be indicative of, or comprise, vast information about the entities 110 including, but not limited to, their identification details, performance information, and resource capabilities. By consolidating vast amounts of information about entities 110, comprising their identification details, performance metrics, and resource capabilities, the entity intelligence database 112 may enable more informed decision-making and streamlined operations across the MECN 106. Such wealth of data may be leveraged to optimize the supply chain processes, identify potential entities 110 (such as partners or collaborators), and mitigate risks associated with entity selection.

The entity intelligence database’s comprehensive nature allows for a holistic view of each entity's strengths, weaknesses, capabilities, and overall performance, facilitating better matching of resources to specific needs within the MECN 106 or the supply chain network. Furthermore, the entity intelligence database 112 may enhance transparency and accountability within the MECN 106. With access to detailed indicators and metrics, more objective assessments of entity capabilities can be made, and improvements can be tracked over time. Additionally, the database can serve as a valuable tool for identifying trends, predicting potential issues, and proactively addressing challenges in the supply chain or collaborative network.

The preparation of such a comprehensive entity intelligence database 112 may involve a multifaceted approach, drawing from various data sources and methodologies. In one example, such a comprehensive entity intelligence database 112 may be prepared based on data collected by monitoring past or historical supply chain transactions between the plurality of entities 110 linked with the same or different MECN 106. The data collection may provide direct insights into metrics corresponding to resource attributes or KPIs. For example, information related to delivery times, quality control rates, and compliance success rates may be collected through automated tracking of transactions and interactions between entities 110.

In addition to transaction monitoring, the entity intelligence database 112 can be enriched through active data gathering from the entities themselves. This may involve periodic surveys, self-reporting mechanisms, or direct integration with entities' internal systems to extract relevant information about their capabilities, resources, and performance metrics. The database preparation process may also incorporate external data sources, such as industry reports, regulatory filings, and public records, to provide a more comprehensive view of each entity's standing and capabilities within their respective industries.

Further, to ensure the accuracy and relevance of the data, the preparation process, in one example, may include robust data validation and verification mechanisms. This may involve, for instance, cross-referencing information from multiple sources, implementing data quality checks, and establishing protocols for regular updates and maintenance of the entity intelligence database 112. In one example, the collected data may directly be indicative of metrics corresponding to resource attributes or KPIs.

In another example, such data may be processed using any known technique to derive various metrics, resource attributes, or KPIs. For example, machine learning algorithms and data analytics tools can also be employed to process and derive various metrics, resource attributes, or KPIs from the data collected, transforming it into actionable intelligence. The database preparation may also consider industry best practices and standards across various supply chain networks. This approach ensures that the metrics and attributes captured in the entity intelligence database 112 are relevant and comparable across different entities 110. By incorporating widely recognized performance indicators and compliance standards, the entity intelligence database 112 can provide a standardized framework for evaluating and comparing entities 110.

In one example, the empirical entity indicator and the empirical resource indicator of each of the plurality of entities 110 may be stored or maintained in secure and separate virtual data containers in the datastore 104. Such secure and separate virtual data containers may be collectively referred to as entity intelligence database 112. In another example, the empirical entity indicator and the empirical resource indicator of each of the plurality of entities 110 may be stored or maintained in a single virtual data container in the datastore 104, and that data container may be referred to as the entity intelligence database 112.

Further, in one example, the entity intelligence database 112 may be a structured database, and the information stored therein can be queried. For example, the entity intelligence database 112 may comprise one or more tables having rows and columns indicating a mapping between each entity and their corresponding empirical entity indicators and entity resource indicators, as illustrated in FIG. 2. FIG. 2 illustrates the entity intelligence database 112, according to one example of the present subject matter.

As illustrated, the entity intelligence database 112 may indicate a mapping between the plurality of empirical resource indicators, the plurality of empirical resource indicators, and the plurality of entities 110. For example, the entity intelligence database 112 may indicate the empirical entity indicators and entity resource indicators linked with the entity 110-1, the empirical entity indicators and the entity resource indicators linked with the entity 110-2,…., and the empirical entity indicators and entity resource indicators linked with the entity 110-N. Further, the entity intelligence database 112 illustrated in FIG. 2 indicates a few examples of the empirical entity indicators and the empirical resource indicators, for the sake of brevity. However, other examples of the empirical entity indicators and the empirical resource indicators, including those discussed above, may be stored similarly in the entity intelligence database 112.

Further, the computing environment 100 may comprise the system 102 communicably linked with at least one of the entity intelligence database 112, the MECN 106, and the entities 110. In one example, the system 102 may be capable of assisting in assessment and identification of one or more entities 110 within the MECN 106, as will be discussed. In one example, the system 102 may also be capable of generating recommendations for indicating the identified entities 110.

In one example, the system 102 may be implemented in the computing environment 100 as a set of one or more hardware devices or modules. For example, the system 102 may be implemented as a set of one or more hardware devices, comprising at least a processor 114. The processor 114 may be implemented as a dedicated processor, a shared processor, or a plurality of individual processors, some of which may be shared. Examples of the processor 114 may include, but are not limited to, microprocessors, microcomputers, microcontrollers, digital signal processors, central processing units, state machines, Artificial Intelligence (AI) based processors, machine learning-based processors, deep learning-based processors, system-on-chip (SOC), processing circuitries including one or more modules or engines, and/or any other devices that manipulate signals and data based on computer-readable instructions.

In another example, the system 102 may be implemented as a set of computer-executable instructions. In this example, the processor 114 may be an engine capable of executing the set of computer-executable instructions that may process the operations data for data reconciliation and recommend a range of values for the parameters. Examples of the system 102, according to this example, may include, but are not limited to, software applications, cloud-based platforms, and Software as a Service (SaaS). In yet another example, the system 102 may be implemented as a combination of the one or more hardware devices and the set of computer-executable instructions. In this example, the set of computer-executable instructions may be executed by the processor 114 for assessment and identification of one or more entities 110 within the MECN 106.

Further, in one example, the computing environment 100 may also include a workstation 116, as illustrated in FIG. 1B. In some examples, the workstation 116 may be a software-based application or tool. Examples of such tools and software may include, but are not limited to, data analysis tools, supply chain tracking and management software, websites or webpages, and cloud-hosted platforms. In some instances, the workstation 116 may be a hardware-based device. Examples of such workstation 116 may include, but are not limited to, a computing system or a desktop, a mobile, a laptop, Supervisory Control and Data Acquisition (SCADA) system. Such a workstation 116, in one example, may execute software-based applications or tools that may be accessed by a user. A user may be, for example, an engineer, operator, worker, or any other industrial expert associated with a supply chain network.

Further, in one example, the workstation 116 may comprise a display device and an input mechanism. The input mechanism may be, for example, a keyboard, mouse, or even a touch input received on the display device of the workstation 116. In one example, the display device may be capable of rendering graphical user interface(s). The workstation 116 may render one or more graphical user interfaces that may be capable of indicating different information about the MECN 106 or the entities 110. The graphical user interface may also be, for example, an interactive platform or interface with which the user may be able to interact. For example, the user may be able to submit queries and view, interact, modify, and customize the information being rendered via the display device and the input mechanism associated with the workstation 116. In one example, the graphical user interface may be a dashboard that may be rendered on the display device.

Further, FIGS. 1A and 1B illustrate that the system 102 may be communicably coupled with at least one of the datastore 104, the MECN 106, the communication network 108, the entities 110, the entity intelligence database 112, and the workstation 116. However, other implementations may also be possible. For example, the system 102 may only be communicably coupled with the datastore 104 to access entity intelligence database 112 stored therein. In another example, MECN 106 may comprise the system 102 or the processor 114, the entities 110, and the entity intelligence database 112, as illustrated in FIG. 1C, for assessment and identification of entities 110, as will be discussed. Similarly, different architectures may also be possible, though not illustrated.

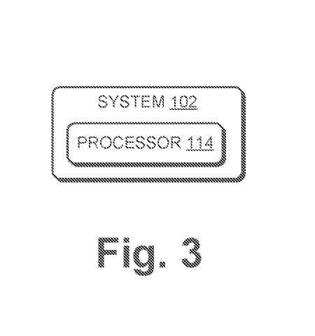

FIG. 3 illustrates a block diagram of the system 102, according to one example implementation of the present subject matter. FIG. 3 may be discussed in conjunction with FIGS. 1A to 2 and the description of FIGS. 1A to 2 shall be referenced herein for the sake of brevity. In one example, the system 102 may be capable of identifying a set of entities from amongst the plurality of entities 110 linked with the MECN 106.

In one example, the system 102 may comprise the processor 114. In one example operation, the processor 114 may receive an entity identification signal for identifying a set of entities from amongst the plurality of entities 110 linked with the multistage entity coordination network 106. The processor 114, based on the entity identification signal, may determine at least one of a set of entity descriptors indicating one or more identification characteristics about the set of entities and a set of resource descriptors indicating one or more resource characteristics to be complied by the set of entities.

Further, the processor 114 may determine, from the entity intelligence database 112, at least one of a set of empirical entity indicators correlating with the set of entity descriptors and a set of empirical resource indicators, for the set of empirical entity indicators, correlating with the set of resource descriptors. The entity intelligence database 112, as discussed above in one example, may comprise the plurality of empirical resource indicators and the plurality of empirical entity indicators, where each of the plurality of empirical entity indicators identifies one of the plurality of entities 110 and each of the plurality of empirical resource indicators is linked with an entity 110 and indicates a resource attribute of that entity 110.

Based on at least one of the set of empirical entity indicators and the set of empirical resource indicators, the processor 114 may identify the set of entities from amongst the plurality of entities 110, where the set of entities probably complies with the one or more resource characteristics indicated in the entity identification signal. The processor 114 may then generate a multistage entity indication signal to cause rendering of the identified set of entities.

The disclosed techniques enhance management of the MECN 106 by utilizing the comprehensive entity intelligence database 112 to improve visibility and access to detailed information about entities 110 involved in MECN 106, such as one or more supply chain networks. This improved visibility supports data-driven decision-making, leading to more confident and efficient entity selection in the MECN 106. Further, by identifying entities based on specific characteristics or capabilities, resource allocation and utilization may be optimized, resulting in a more integrated, transparent, and effective supply chain management approach.

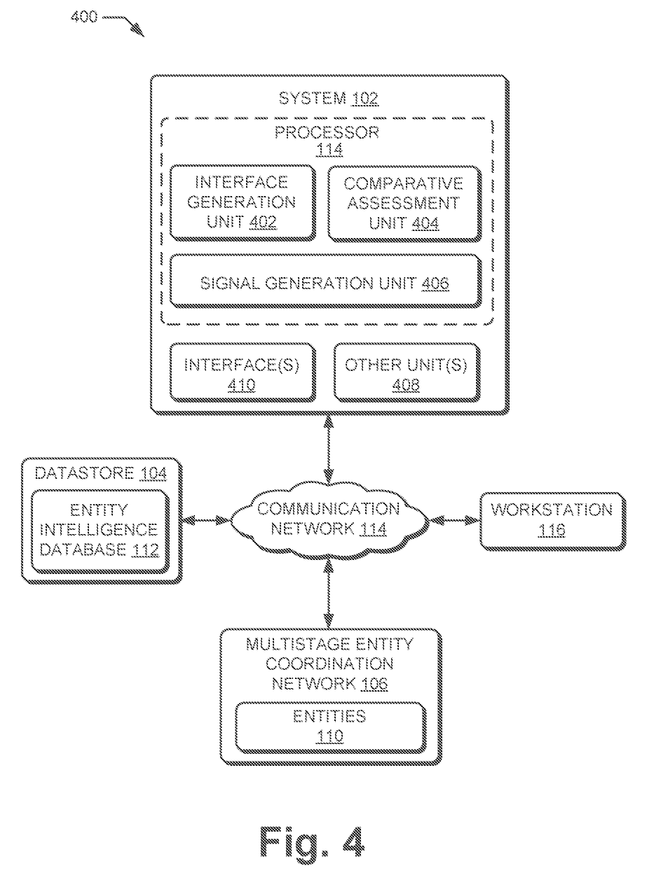

FIG. 4 illustrates a block diagram of a computing environment 400, according to one example implementation of the present subject matter. FIG. 4 will be discussed in conjunction with FIGS. 1A to 2, with the descriptions of FIGS. 1A to 2 incorporated by reference for brevity.

In one example, the computing environment 400 may be similar to the computing environment 100, as discussed in reference to FIGS. 1A to 1C. For example, the computing environments 100 and 400 may be any environment or network comprising the system 102 communicably connected with the entity intelligence database 112 and at least one of the datastore 104, the MECN 106, the plurality of entities 110 linked with the MECN 106, and the workstation 116. The communicable connection may be direct or through the communication network 108 as discussed above.

In one example, the system 102 may be capable of assisting in the assessment and identification of one or more entities 110, interchangeably referred to as a set of entities 110, within the MECN 106. In one example, the system 102 may be capable of accessing the entity intelligence database 112 for comprehensive assessment and identification of the set of entities 110. The system 102 may also be capable of generating recommendations for indicating the identified set of entities 110. For example, the system 102 may present recommendations in a user-friendly format, for instance, through visualisations or dashboards.

In one example, the system 102 comprises the processor 114. The processor 114 may be implemented as a dedicated processor, a shared processor, or a plurality of individual processors, some of which may be shared. Examples of the processor 114 may include, but are not limited to, microprocessors, microcomputers, microcontrollers, digital signal processors, central processing units, state machines, Artificial Intelligence (AI) based processors, machine learning-based processors, deep learning-based processors, system on chip (SOC), processing circuitries including one or more modules or engines, and/or any other devices that manipulate signals and data based on computer-readable instructions, and/or any other devices.

In one example, the processor 114 may include one or more sub-processing units or engines. For example, the processor 114 may comprise an interface generation unit 402, a comparative assessment unit 404, and a signal generation unit 406. The units may be implemented as a combination of hardware and programming, for example, programmable instructions to implement a variety of functionalities of the units. In examples described herein, such combinations of hardware and programming may be implemented in several different ways. For example, the programming for the units or engines may be executable instructions. Such instructions in turn may be stored on a non-transitory machine-readable storage medium which may be coupled with the system 102 either directly or indirectly (for example, through networked means). In an example, it may also be possible that each of the units or engines includes a processing resource, for example, a single processor or a combination of multiple processors, to execute such instructions. In one example, such instructions may be stored in a memory of other unit(s) 408 of the system 102. In other examples, the units or engines may be implemented as electronic circuitry.

The system 102 may comprise, in one example, interface(s) 410. The interface(s) 410 may include a variety of software and hardware interfaces that allow interaction of the system 102 with other communication and computing devices, such as network entities, web servers, external repositories, and peripheral devices, such as input/output (I/O) devices. For example, the interface(s) 410 may communicably couple the system 102 with the entity intelligence database 112 and at least one of the datastore 104, the MECN 106, the plurality of entities 110 of the MECN, and the workstation 116. The interface(s) 410 may also enable the coupling of internal components of the system 102 with each other.

The system 102 may further comprise, in one example, the other unit(s) 408. The other unit(s) 408 may include, in one example, a power supply unit, a communication unit, and the memory. The power supply unit may, for example, manage distribution or supply of electrical current within the system 102 for functioning of the system 102. Further, the communication unit may be, in one example, a wireless communication unit. Examples of the communication unit may include, but are not limited to, Global System for Mobile communication (GSM) modules, Code-division multiple access (CDMA) modules, Bluetooth modules, network interface cards (NIC), Wi-Fi modules, dial-up modules, Integrated Services Digital Network (ISDN) modules, Digital Subscriber Line (DSL) modules, and cable modules. In one example, the communication unit may also include one or more antennas to enable wireless transmission and reception of data and signals. The communication unit may allow the system 102 to be communicably coupled with the entity intelligence database 112 and at least one of the datastore 104, the MECN 106, the plurality of entities 110 of the MECN, and the workstation 116. Also, the communication unit may allow the system 102 to transmit and receive data, files, and/or signals.

Further, the memory may include any computer-readable medium known in the art including, for example, volatile memory, such as Static Random-Access Memory (SRAM) and Dynamic Random-Access Memory (DRAM), and/or non-volatile memory, such as Read Only Memory (ROM), Erasable Programmable ROMs (EPROMs), flash memories, hard disks, optical disks, and magnetic tapes. In one example, the memory may store the data received, processed, or generated by the system 102 and/or the processor 114.

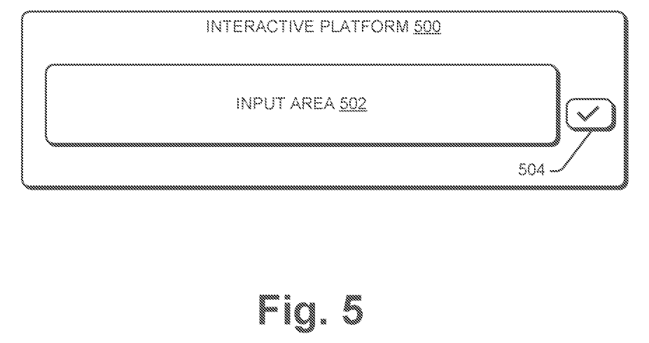

In one example operation, the processor 114 may receive an entity identification signal for identifying a set of entities from amongst the plurality of entities 110 linked with the multistage entity coordination network 106. In one example, the entity identification signal may be received from an interactive platform 500. FIG. 5 illustrates a block diagram of the interactive platform 500, according to one example implementation of the present subject matter. The interactive platform 500, in one example, may be a graphical user interface and may be accessed by a user to submit a query to identify a suitable or desired set of entities in the MECN 106. Examples of the interactive platform 500 may include, web pages, websites, an interface generated by any software, a cloud-based platform, and a platform or webpage capable of performing searches. Further, examples of the user may include, but are not limited to, one or more individual users, users associated with an organization, and entities of the MECN 106. In one example, the user may access the interactive platform 500 through the workstation 116. In one example, rendering of the interactive platform 500 may be caused by the interface generation unit 402 of the processor 114.

In one example, the interactive platform 500 may include an input area 502 to receive a query from the user. The input area 502 may be capable of receiving queries from the user. In one example, the queries may be in the form of text. In one example, the query may be for the identification of one or more entities, interchangeably referred to as the set of entities, in the MECN 106. For example, the query may be to identify distributors capable of maintaining a temperature range of 20 to 22 degrees Celsius, identify a list of distributors experienced in handling temperature-sensitive drugs, identify warehouses with better metrics, and the like than current partner warehouses. Similarly, there may be different types of queries related to assessment and identification of entities in the MECN 106. Further, the queries may also include a set of queries or any document uploaded by the user in the input area.

In one example, the platform interface 500 may also include a submit button 504 that may enable the user to submit the query. Further, submission of the query may generate the entity identification signal and may be communicated from the platform interface 500 to the processor 114. That is, the entity identification signal may be any signal or instruction received by the processor 114 from the interactive platform 500 that indicates the submission of the query for assessment and/or identification of entities.

Based on the entity identification signal, the processor 114 may determine at least one of a set of entity descriptors indicating one or more identification characteristics about the set of entities and a set of resource descriptors indicating one or more resource characteristics to be complied by the set of entities. For example, if the query was for identification of distributors capable of maintaining a temperature range of 20 to 22 degrees Celsius, the set of entity descriptors may be “distributors” as it may identify characteristics of the set of entities, i.e., distributors.

Further, the set of resource descriptors may be “maintaining a temperature range of 20 to 22 degrees Celsius”, indicating one or more resource characteristics to be complies by the set of entities (for instance, the distributors). The requirement of maintaining a certain temperature range may indicate that an entity should possess resources of appropriate characteristics or capabilities for being able to maintain that temperature range. Thus, the requirement of maintaining the temperature range may be indicative of characteristics of resources required to be complied by the set of entities.

Similarly, if the query was to identify warehouses with better metrics, “warehouses” may be identified as the set of entity descriptors and “better metrics” may be identified as the set of resource descriptors. For example, as entities with better resources may have better metrics or KPIs, such a query may thus be indicative that entities with better resources (and thus resource characteristics) should be identified. In one example, better may refer to entities with high resource characteristics, say above a threshold level defined by the user in the query itself. In another example, better may refer to entities with better resource characteristics than current entities being used by the user. In one example, information about current entities being used by the user may be provided by the user. In another example, the datastore 104 may store data or information indicating the entities currently linked with the user and their resource characteristics. For example, the datastore 104 may store information about linkages between entities 110 and their users based on transactions in the MECN 106.

In one example, the processor 114 may process the query to determine the set of entity descriptors and the set of resource descriptors from the received entity identification signal. In one example, the processor 114, or the comparative assessment unit 404, may parse the entity identification signal or the query to identify keywords that specify a category of supply chain participants (for example, "distributors," "suppliers," "manufacturers", and the like). The processor 114 may look for subject-oriented terms that define "who" or "what" is being identified. For example, in the above query, “distributors” defines the supply chain entity.

Further, as the resource descriptors may represent the conditions, capabilities, or constraints that the entities 110 must comply with, these may typically include measurable requirements, qualifications, or constraints. Thus, to determine the set of resource characteristics from the query, the processor 114 may analyze the query for descriptive phrases that specify conditions (for example, "must maintain," "capable of," "required to") and identify numerical values, units, or qualitative requirements (for example, "temperature range of 20 to 22 degrees Celsius").

In another example, the processor 114 may parse the query and split the query into individual words or tokens. For example, the tokenized query may be "Identification", "distributors", "capable", "maintain", "temperature", "range", "20", "22", "degrees", "Celsius”. The processor 114 may then extract the set of entity descriptors specifying who or what is being identified in the query. In one example, the processor 114 may utilize Named Entity Recognition (NER) to identify entities like organizations, people, or roles using Natural Language Processing (NLP) model(s). In this case, entity types related to supply chain roles (for example, "distributors," "suppliers") may be extracted. In one example, the processor 114 may access trained NLP model(s) through the communication network 108.

In another example, trained NLP model(s) may be locally deployed as a part of the system 102, other unit(s) 408, as a unit of the processor 114 and may be locally accessible to the processor 114. Further, nouns that act as subjects or objects of the query may be identified, for example, the query for "identification of [X]" patterns, where X is the supply chain entity. The NLP models may be fine-tuned on domain-specific corpora to improve their performance for such extraction of information.

Further, to extract the set of resource descriptors, the processor 114 may perform pattern matching and phrase detection to identify phrases that describe conditions (for example, "capable of [X]", "must maintain [Y]"). May Processor 114 may look for verbs related to abilities (for example, "maintain," "support," and "handle") in the entity identification signal. The processor 114 may further perform numerical and unit extraction to detect numerical values and measurement units using Regular Expressions (Regex). The query may also be parsed to identify phrases that describe the entity’s requirements. For example, "maintaining a temperature range of 20 to 22 degrees Celsius" may be extracted as a requirement, i.e., the set of resource descriptors.

Similarly, other different approaches can also be utilised to determine keywords that may amount to the set of entity descriptors and the set of resource descriptors from the entity identification signal or query. Further, the set of entity descriptors may include one or more entity descriptors and the set of resource descriptors may include one or more resource descriptors determined or extracted, as discussed above, based on the entity identification signal.

The processor 114, or the comparative assessment unit 404, may then determine, from the entity intelligence database 112, at least one of a set of empirical entity indicators correlating with the set of entity descriptors and a set of empirical resource indicators, for the set of empirical entity indicators, correlating with the set of resource descriptors. As discussed above, the entity intelligence database 112 comprises the plurality of empirical resource indicators and the plurality of empirical entity indicators. Each of the plurality of empirical entity indicators identifies an entity from amongst the plurality of entities 110. For example, each entity may have an empirical entity indicator linked therewith. Further, each of the plurality of empirical resource indicators is linked with an entity and indicates a resource attribute of that entity. For example, an entity may have one or more empirical resource indicators linked therewith, indicating the resource attributes of that entity, as discussed above.

In one example, the processor 114 may perform a first comparative assessment between each entity descriptor, in the set of entity descriptors, and each empirical entity indicator in the plurality of empirical entity indicators to determine the set of empirical entity indicators correlating with the set of entity descriptors. The comparative assessment may be performed using various techniques and approaches. Comparison techniques, for example, advanced string-matching algorithms, word embedding-based comparisons, and contextual embeddings may be used.

Advanced string-matching techniques may include, for example, edit distance algorithms, phonetic matching algorithms, or similarity coefficient algorithms, which may be useful for handling minor variations in entity descriptors. Word embedding-based comparisons may utilize pre-trained static word embedding models to convert entity descriptors and empirical entity indicators into dense vector representations.

Contextual embeddings may employ more advanced language models to generate context-aware embeddings for entity descriptors and empirical entity indicators. In some aspects, the processor 114 may utilize hybrid approaches combining multiple techniques, such as ensemble methods or multi-stage matching pipelines, to improve overall entity matching accuracy. In another example, the processor 114 may utilize Jaccard similarity, or cosine similarity techniques for the identification of empirical entity indicators correlating or matching with the one or more entity descriptors in the set of entity descriptors. In another example, the comparative assessment may be a semantic similarity assessment performed by utilizing the NLP model(s) or other language models.

Thus, the first comparative assessment may be performed to compare each entity descriptor, in the set of entity descriptors, with each empirical entity indicators stored in the entity intelligence database 112, to identify one or more entity empirical entity indicators (interchangeably referred to as the set of entity empirical entity indicators) that correlate or match with the one or more entity indicators in the set of entity indicators derived from the entity identification signal. The set of entity indicators may include one or more empirical entity indicators from amongst the plurality of empirical entity indicators. For example, the first comparative assessment may result in identifying names, role in supply chain, and/or other identifiers that may semantically or logically represent “distributors” (i.e., the entity descriptor received in the query).

As such information is linked with entities 110, as discussed above and indicated in FIG. 2, the information may be indicative of candidate entities that may probably be the entities that are to be identified. For example, the candidate entities may be entities 110-1 to 110-5 from amongst the entities 110-1 to 110-N. However, in one example, further assessment may be required to narrow down or validate whether the candidate entities possess the resource characteristics to address the requirements indicated in the query or the entity identification signal.

In one example, the processor 114 may perform a second comparative assessment for the determined set of empirical entity indicators. The second comparative assessment may be performed between each empirical resource indicator, linked with each empirical entity indicator in the set of empirical entity indicators, and each resource descriptor, in the set of resource descriptors, to determine the set of empirical resource indicators, for the determined set of empirical entity indicators, correlating with the set of resource descriptors.

In one example, the second comparative assessment may be performed similarly to the first comparative assessment. However, instead of assessing the entity descriptors and empirical entity indicators, the second comparative assessment is performed by assessing the empirical resource indicators, linked with the empirical entity indicators identified in the first comparative assessment, and the set of resource descriptors. For example, empirical resource indicators semantically conforming with one or more resource indicators in the set of resource indicators may be identified in the second comparative assessment.

Considering the above example of maintaining a certain temperature range, the processor 114 may perform the second assessment to determine empirical resource indicators or KPIs that indicate, semantically or logically, the capability of maintaining that temperature range. Such empirical resource indicators, linked with the empirical entity indicators identified in the first assessment, may be determined by the processor 114. Such empirical resource indicators may be referred to as the set of empirical resource indicators correlating with the set of resource indicators. Thus, the second comparative assessment may be performed to determine the set of empirical resource indicators, for the empirical entity indicators in the set of empirical entity indicators identified in the first comparative assessment.

Based on at least one of the set of empirical entity indicators and the set of empirical resource indicators, the processor 114 may identify a set of entities from amongst the plurality of entities 110. As discussed above and also illustrated in FIG. 2, each of the plurality of entities 110 may have empirical entity indicators and empirical resource indicators linked or mapped therewith. Based on such mapping, the processor 114 may identify one or more entities, interchangeably referred to as the set of entities, that correspond to at least one of the set of empirical entity indicators and the set of empirical resource indicators. For example, the entities mapped to the empirical entity indicators and the empirical resource indicators were determined based on the comparative assessments may be identified. Further, the set of entities may probably comply with the one or more resource characteristics indicated in the entity identification signal, as a result of the second comparative assessment performed between the resource descriptors and the empirical resource indicators.

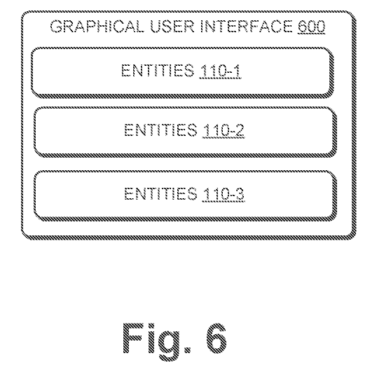

Further, the processor 114, or the signal generation unit 406, may then generate a multistage entity indication signal to cause rendering of the identified set of entities. The multistage entity indication signal may be a signal, command, or set of instructions that may be generated by the processor 114. By generating the multistage entity indication signal, the processor 114 may trigger rendering of a graphical user interface to indicate the identified set of entities probably complying with the one or more resource characteristics indicated in the entity identification signal. FIG. 6 illustrates a block diagram of a graphical user interface 600 indicating the set of entities, according to one example implementation of the present subject matter. For instance, the entities 110-1 to 110-3 may be the set of entities, as illustrated.

In one example, the graphical user interface 600 may be rendered at a location or device from where the entity identification signal was generated and/or received. For example, the graphical user interface 600 may be rendered on the interactive platform 500 and/or the display device of the workstation 116. In one example, rendering of the set of entities may mean rendering details, such as the empirical entity identifiers and the empirical resource identifiers, linked with each entity in the set of entities, though not illustrated. For example, name, roles, and KPI(s) of the set of entities may be rendered on the graphical user interface.

Further, in one example, the set of identified entities may be indicated in accordance with a prescribed schema. For example, if the set of entities includes entities 110-1 to 110-3, the entities may be indicated in an order in which they were identified in the comparative assessment, as illustrated in FIG. 6. In another example, the entities in the set of entities may be indicated in an order which may be based on the extent of similarity with the entity descriptors and/or resource descriptors. For example, the semantic similarity may quantify the extent of similarity between empirical entity indicators and entity descriptors; and/or empirical resource indicators and the resource descriptors. Similarly, other schemas may also be prescribed for more informatively indicating the set of entities.

Further, in one example, the set of entities may include entities that may be linked with different interlinked stages of the supply chain network. For example, if a query indicated a requirement for identification of different types of entities (say, warehouse and distributor) with their corresponding resource characteristics, the entities from different stages may be recommended by performing the comparative assessment as discussed above.

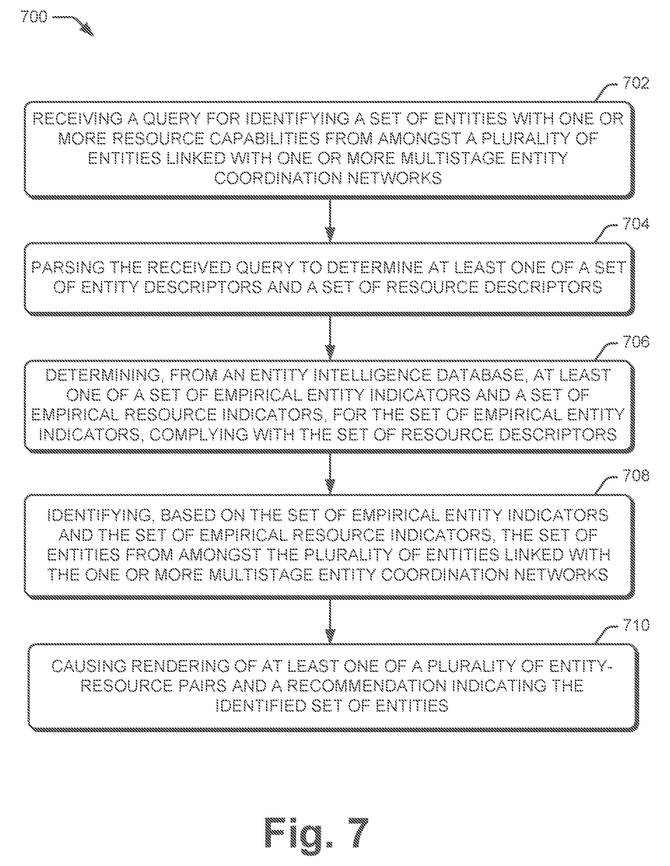

FIG. 7 illustrates an exemplary method 700 for identification of one or more entities in one or more multistage entity coordination networks, according to one example implementation of the present subject matter. The order in which the method is described is not intended to be construed as a limitation, and any number of the described method blocks may be combined in any order to implement the method 700, or an alternative method. Furthermore, the method 700 may be implemented by processing resource or computing device(s) through any suitable hardware, non-transitory machine-readable instructions, or combination thereof.

It may also be understood that the method 700 may be performed by programmed computing devices, such as the processor 114, as depicted in FIGS. 3 and 4. Furthermore, the method 700 may be executed based on instructions stored in a non-transitory computer-readable medium, as will be readily understood. The non-transitory computer-readable medium may include, for example, digital memories, magnetic storage media, such as one or more magnetic disks and magnetic tapes, hard drives, or optically readable digital data storage media. While the method 700 is described below with reference to the processor 114 and the system 102 as described above; other suitable systems for the execution of these methods may also be utilized. Additionally, the implementation of these methods is not limited to such examples. Further, FIG. 7 will be discussed in conjunction with FIGS. 1A to 6 for the sake of brevity and the description of FIGS. 1A to 6 shall be incorporated herein for reference.

At block 702, a query may be received for identifying a set of entities with one or more resource capabilities from amongst a plurality of entities linked with one or more multistage entity coordination networks. As discussed above, the query may be received from an interactive platform, such as the interactive platform 500, linked with the one or more multistage entity coordination networks, such as one or more MECNs 106. In one example, each of the one or more multistage entity coordination networks may comprise a plurality of interlinked stages and each of the plurality of entities 110 may be linked with one of the plurality of interlinked stages. For example, as in a supply chain network, each of the plurality of entities 110 may be sequentially interlinked based on their roles in the supply chain network, as discussed in above examples.

At block 704, the received query may be parsed to determine at least one of a set of entity descriptors indicating one or more identification characteristics for the set of entities and a set of resource descriptors indicating one or more resource characteristics to be complied by the set of entities. The query may be processed or parsed, as discussed above, to determine the set of entity descriptors and the set of resource descriptors from the query. In one example, the sets may be singleton sets. That is, the set of entity descriptors may include a single entity descriptor and the set of resource descriptors may include a single resource descriptor. In another example, the sets may include two or more entity descriptors and resource descriptors.

At block 706, at least one of a set of empirical entity indicators and a set of empirical resource indicators may be determined from an entity intelligence database, such as the entity intelligence database 112. As discussed above, the set of empirical entity indicators and the set of empirical resource indicators may be determined by performing the comparative assessment. In one example, the entity intelligence database 112 may be queried to identify the set of empirical entity indicators matching the determined set of entity descriptors. For the set of empirical entity indicators, the entity intelligence database 112 may further be queried to determine one or more empirical resource indicators, linked with each empirical entity indicator in the set of empirical entity indicators, matching with the set of resource descriptors.

At block 708, a set of entities may be identified based on at least one of the set of empirical entity indicators and the set of empirical resource indicators. As discussed above, each of the plurality of entities 110 may have the empirical entity indicators and empirical resource indicators linked therewith. Thus, the set of entities linked with at least one of the set of empirical entity indicators and the set of empirical resource indicators may be identified. In one example, the set of entities from amongst the plurality of entities 110 may be linked with the one or more multistage entity coordination networks, such as one or more MECNs 106. The one or more MECNs may be supply chain networks comprising the plurality of entities 110.

At block 710, rendering of at least one of a plurality of entity-resource pairs and a recommendation indicating the identified set of entities may be caused. In one example, rendering of a graphical user interface, such as the graphical user interface 600, may be triggered to indicate at least one of the plurality of entity-resource pairs and the recommendation indicating the identified set of entities.

As discussed above, recommendation indicating the identified set of entities may be rendered on the graphical user interface 600, where the set of entities complies with the one or more resource characteristics indicated in the received query. Further, in one example, rendering of the plurality of entity-resource pairs may also be caused. Each of the plurality of entity-resource pairs may indicate an entity and a resource attribute indicated by the empirical resource indicators linked with that entity. The plurality of entity-resource pairs may be formed based on linkages between the set of entities and the set of empirical resource indicators indicated by the entity intelligence database 112. For example, each entity in the set of entities may have empirical resource indicators mapped therewith, as indicated by the entity intelligence database 112.

Thus, based on such mapping or linkages a plurality of entity-resource pairs may be rendered. Such pairs may indicate, for example, which entity in the set of entities has what resource attributes. Thus, a detailed insight may be rendered that may clearly provide a holistic view of which entities, in the set of entities, have what resource attributes. Such indication may also assist in additional verification of whether the set of entities complies with the one or more resource characteristics indicated in the received query.

Further, in one example, the recommendation may indicate a probable linkage between each entity in the set of entities based on their linkage with the interlinked stages of the one or more MECNs 106. For example, as discussed in above examples, in the supply chain network, each of the plurality of entities 110 may be sequentially interlinked based on their roles in the supply chain network. Based on such sequence, the entities in the set of entities may be interlinked. For example, entities, in the set of entities, that are linked with a first stage in the supply chain, may be ordered first, followed by entities linked with a second stage, a third stage of the supply chain. Accordingly, the recommendation may indicate such linkages between each entity in the set of entities.

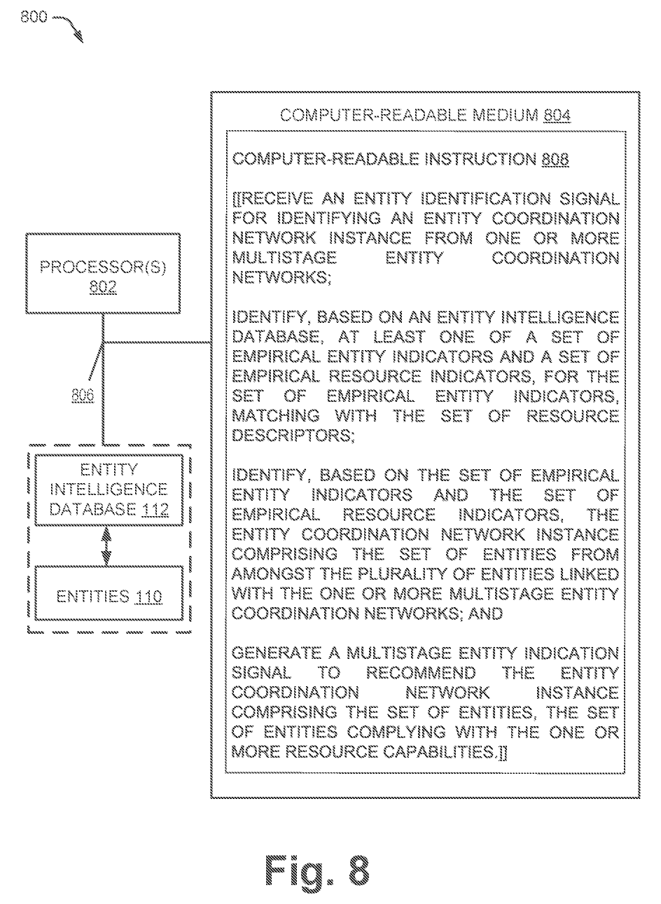

FIG. 8 illustrates a non-transitory computer-readable medium for identifying a set of entities for forming an entity coordination network instance, according to one example implementation of the present subject matter. FIG. 8 will be discussed in conjunction with FIGS. 1A to 7, and the description of FIGS. 1A to 7 shall be incorporated herein for reference and for the sake of brevity.

In an example, the computing environment 800 includes a processor 802 communicatively coupled to a non-transitory computer-readable medium 804 through communication link 806. In an example, the processor 802 may have one or more processing resources for fetching and executing computer-readable instructions from the non-transitory computer-readable medium 804. The processor 802 and the non-transitory computer-readable medium 804 may be implemented, for example, in the system 102.

The non-transitory computer-readable medium 804 may be, for example, an internal memory device or an external memory. In an example implementation, the communication link 806 may be a network communication link, or other communication links, such as a PCI (Peripheral component interconnect) Express, USB-C (Universal Serial Bus Type-C) interfaces, I2C (Inter-Integrated Circuit) interfaces, etc. In an example implementation, the non-transitory computer-readable medium 804 includes a set of computer-readable instructions 808 which may be accessed by the processor 802 through the communication link 806. The processor 802 and the non-transitory computer-readable medium 804 may also be communicatively coupled to the entity intelligence database 112 and the entities 110, as illustrated. In another example, the processor 802 and the non-transitory computer-readable medium 804 may be communicatively linked to the datastore 104, where the datastore 104 may store the entity intelligence database 112.

Referring to FIG. 8, in an example, the non-transitory computer-readable medium 804 includes computer-readable instructions 808 that may cause the processor 802 to receive an entity identification signal for identifying an entity coordination network instance from one or more multistage entity coordination networks. As discussed above, in one example, the entity identification signal may be received from the interactive platform 500 and may indicate at least one of the set of entity descriptors indicating one or more identification characteristics about the set of entities for entity coordination network instance and the set of resource descriptors indicating one or more resource characteristics to be complied by the set of entities for entity coordination network instance. As discussed above, the processor 802, similar to the processor 114, may be capable of parsing the entity identification signal and determining the set of entity descriptors and the set of resource descriptors.

In one example, the entity identification signal may be for identification of the set of entities and, thereby identifying the entity coordination network instance from amongst the one or more multistage entity coordination networks, like one or more of the MECN 106. In one example, the entity coordination network instance may comprise the set of entities from amongst the plurality of entities 110 linked with the one or more MECNs. As discussed above, each of the one or more MECNs may comprise a plurality of interlinked stages and each of the plurality of entities 110 may be linked with one of the plurality of interlinked stages. In one example, the entity coordination network instance may thus be formed by the set of entities that may comprise entities linked with different stages from amongst the plurality of interlinked stages.

In other words, the entity coordination network instance may be a supply chain path or route being formed by the set of entities, where the set of entities may comprise entities that may be linked with different stages from amongst the plurality of interlinked stages. For example, as discussed in the above examples, in the supply chain network, each of the plurality of entities 110 may be sequentially interlinked based on their roles in the supply chain network. Based on such sequence, the entities in the set of entities may be interlinked, thus forming an instance of the MECNs, and being referred to as the entity coordination network instance. In one example, the entity identification signal may be for identification of the set of entities, and thus the entity coordination network.

In an example, the non-transitory computer-readable medium 804 includes computer-readable instructions 808 that may cause the processor 802 to identify, based on the entity intelligence database 112, at least one of the set of empirical entity indicators matching with the set of entity descriptors and the set of empirical resource indicators, for the set of empirical entity indicators, matching with the set of resource descriptors. In one example, the processor 802, similar to the processor 114, may be capable of performing the comparative assessments to determine the set of empirical entity indicators and, for the set of empirical entity indicators, the set of empirical resource indicators from the entity intelligence database 112.

As discussed above, the entity intelligence database 112 comprises the plurality of empirical resource indicators and the plurality of empirical entity indicators, where each of the plurality of empirical entity indicators identifies one of the plurality of entities and each of the plurality of empirical resource indicators is mapped with an entity and indicates a resource attribute of that entity. That is, the entity intelligence database 112 includes a collection of empirical resource indicators and empirical entity indicators. Each empirical entity indicator corresponds to one of the entities in the database and each empirical resource indicator is associated with an entity and specifies a resource attribute of that entity.

In an example, the non-transitory computer-readable medium 804 includes computer-readable instructions 808 that may cause the processor 802 to identify, based on at least one of the set of empirical entity indicators and the set of empirical resource indicators, the entity coordination network instance comprising the set of entities from amongst the plurality of entities 110 linked with the one or more MECNs. As discussed above, each entity may have mapped therewith the empirical entity indicators identifying that entity and the empirical resource indicators indicating resource attributes of that entity.

Thus, based on at least one of the set of empirical entity indicators and the set of empirical resource indicators, the set of entities may be identified. Further, in one example, as each entity may be linked with a stage from amongst the plurality of stages, it may be possible that the set of entities may include entities linked with different stages. as the stages may be sequentially linked, the entities in the set of entities may be linked in accordance with their stages. Thus, a path or route, interchangeably referred to as the entity coordination network instance, between multiple stages may be indicated by the identified set of entities.

In an example, the non-transitory computer-readable medium 804 includes computer-readable instructions 808 that may cause the processor 802 to generate a multistage entity indication signal to recommend the entity coordination network instance comprising the set of entities. In one example, by generating the multistage entity indication signal, the processor 802 may trigger rendering of a graphical user interface to indicate the entity coordination network instance comprising the set of entities.

In one example, a probable linkage between each entity in the set of entities, based on their linkage with the interlinked stages, may be indicated on the graphical user interface, thus indicating the entity coordination network. For example, entities, in the set of entities, that are linked with a first stage in the supply chain may be linked with entities linked with a second stage, followed by a third stage, and so on, thus forming a networked route of entities, and being referred to as the entity coordination network.

The present subject matter addresses issues related to limited visibility, which restricts the scope of selecting suitable entities, specially from across a supply chain. By utilizing the comprehensive entity intelligence database 112 that includes details of multiple supply chains and the entities involved, visibility into the details of entities linked to one or more supply chains is enhanced. Also, the entity coordination network instance may indicate a possible route assisting in coordinating a network between such entities. Improved visibility facilitates data-driven identification of suitable entities and network instances, potentially leading to more confident entity selection and improved supply chain efficiency.

Although examples of the present subject matter have been described in language specific to methods and/or structural features, it is to be understood that the present subject matter is not limited to the specific methods or features described. Rather, the methods and specific features are disclosed and explained as examples of the present subject matter.

What is claimed is:

1. A system comprising:
a processor to:
receive an entity identification signal for identifying a set of entities from amongst a plurality of entities linked with a multistage entity coordination network;
determine, based on the entity identification signal, at least one of:
a set of entity descriptors indicating one or more identification characteristics about the set of entities; and
a set of resource descriptors indicating one or more resource characteristics to be complied by the set of entities;
determine, from an entity intelligence database, at least one of:
a set of empirical entity indicators correlating with the set of entity descriptors; and
a set of empirical resource indicators, for the set of empirical entity indicators, correlating with the set of resource descriptors,
wherein the entity intelligence database comprises a plurality of empirical resource indicators and a plurality of empirical entity indicators, wherein each of the plurality of empirical entity indicators identifies one of the plurality of entities and each of the plurality of empirical resource indicators is linked with an entity and indicates a resource attribute of that entity; and
identify, based on at least one of the set of empirical entity indicators and the set of empirical resource indicators, the set of entities from amongst the plurality of entities; and
generate a multistage entity indication signal to cause rendering of the identified set of entities, wherein the set of entities probably complies with the one or more resource characteristics indicated in the entity identification signal.

2. The system of claim 1, wherein the multistage entity coordination network comprises a plurality of interlinked stages, and wherein each of the plurality of entities is linked with at least one of the plurality of interlinked stages.

3. The system of claim 1, wherein the processor is to receive the entity identification signal from an interactive platform linked with the multistage entity coordination network.

4. The system of claim 1, wherein the processor is to:
perform a first comparative assessment between each entity descriptor, in the set of entity descriptors, and each empirical entity indicator in the plurality of empirical entity indicators to determine the set of empirical entity indicators correlating with the set of entity descriptors; and
perform a second comparative assessment for the determined set of empirical entity indicators, wherein the second comparative assessment is performed between each empirical resource indicator, linked with each empirical entity indicator in the set of empirical entity indicators, and each resource descriptor, in the set of resource descriptors, to determine the set of empirical resource indicators, for the determined set of empirical entity indicators, correlating with the set of resource descriptors.

5. The system of claim 1, wherein each of the plurality of empirical resource indicators is a Key Performance Indicator (KPI) linked with a corresponding entity from amongst the plurality of entities.

6. The system of claim 1, wherein the system comprises a datastore communicably linked with the processor, wherein the datastore stores the entity intelligence database.

7. The system of claim 1, wherein the entity intelligence database indicates a mapping between the plurality of empirical resource indicators, the plurality of empirical resource indicators, and the plurality of entities.

8. The system of claim 1, wherein the processor is to trigger rendering of a graphical user interface to indicate the identified set of entities probably complying with the one or more resource characteristics indicated in the entity identification signal.

9. The system of claim 8, wherein the set of identified entities is indicated in accordance with a prescribed schema.

10. A method comprising:
receiving a query for identifying a set of entities with one or more resource capabilities from amongst a plurality of entities linked with one or more multistage entity coordination networks, wherein each of the one or more multistage entity coordination networks comprises a plurality of interlinked stages, and wherein each of the plurality of entities is linked with one of the plurality of interlinked stages;
parsing the received query to determine at least one of:
a set of entity descriptors indicating one or more identification characteristics for the set of entities; and
a set of resource descriptors indicating one or more resource characteristics to be complied by the set of entities;
determining, from an entity intelligence database, at least one of:
a set of empirical entity indicators complying with the set of entity descriptors; and
a set of empirical resource indicators, for the set of empirical entity indicators, complying with the set of resource descriptors, wherein the entity intelligence database comprises a plurality of empirical resource indicators and a plurality of empirical entity indicators, wherein each of the plurality of empirical entity indicators identifies one of the plurality of entities and each of the plurality of empirical resource indicators is linked with an entity and indicates a resource attribute of that entity; and
identifying, based on at least one of the set of empirical entity indicators and the set of empirical resource indicators, the set of entities from amongst the plurality of entities linked with the one or more multistage entity coordination networks;
causing rendering of at least one of:
a plurality of entity-resource pairs, wherein each of the plurality of entity-resource pairs indicates an entity and a resource attribute, the plurality of entity-resource pairs being formed based on linkages between the set of entities and the set of empirical resource indicators indicated by the entity intelligence database; and
a recommendation indicating the identified set of entities, wherein the set of entities complies with the one or more resource characteristics indicated in the received query.

11. The method of claim 10, wherein the recommendation indicates a probable linkage between each entity in the set of entities based on their linkage with the interlinked stages of the one or more multistage entity coordination networks.

12. The method of claim 10, wherein the method further comprises triggering rendering of a graphical user interface to indicate at least one of the plurality of entity-resource pairs and the recommendation indicating the identified set of entities.

13. The method of claim 10, wherein the query is received from an interactive platform linked with the one or more multistage entity coordination networks.

14. The method of claim 10, wherein the one or more multistage entity coordination networks are supply chain networks comprising the plurality of entities.

15. The method of claim 10, wherein each empirical resource indicator in the identified set of empirical resource indicators is linked with an entity, from amongst the set of entities, linked with one of the plurality of interlinked stages of the one or more multistage entity coordination networks.

16. The method of claim 10, wherein the set of resource descriptors comprises one or more Key Performance Indicators (KPIs).

17. A non-transitory computer-readable medium comprising instructions, the instructions being executable by a processing resource to:
receive an entity identification signal for identifying an entity coordination network instance from one or more multistage entity coordination networks, the entity coordination network instance comprising a set of entities from amongst a plurality of entities linked with the one or more multistage entity coordination networks, wherein each of the one or more multistage entity coordination networks comprises a plurality of interlinked stages and each of the plurality of entities is linked with one of the plurality of interlinked stages, and wherein the entity identification signal indicates at least one of:
a set of entity descriptors indicating one or more identification characteristics about the set of entities for entity coordination network instance; and
a set of resource descriptors indicating one or more resource characteristics to be complied by the set of entities for entity coordination network instance;
identify, based on an entity intelligence database, at least one of:
a set of empirical entity indicators matching with the set of entity descriptors; and
a set of empirical resource indicators, for the set of empirical entity indicators, matching with the set of resource descriptors,
wherein the entity intelligence database comprises a plurality of empirical resource indicators and a plurality of empirical entity indicators, wherein each of the plurality of empirical entity indicators identifies one of the plurality of entities and each of the plurality of empirical resource indicators is mapped with an entity and indicates a resource attribute of that entity;
identify, based on at least one of the set of empirical entity indicators and the set of empirical resource indicators, the entity coordination network instance comprising the set of entities from amongst the plurality of entities linked with the one or more multistage entity coordination networks; and
generate a multistage entity indication signal to recommend the entity coordination network instance comprising the set of entities, the set of entities complying with the one or more resource characteristics indicated in the entity identification signal.

18. The non-transitory computer-readable medium of claim 17, wherein the processing resource is to trigger rendering of a graphical user interface to indicate the entity coordination network instance comprising the set of entities.

19. The non-transitory computer-readable medium of claim 18, wherein the set of entities comprises entities linked with different stages from amongst the plurality of interlinked stages of the one or more multistage entity coordination networks.

20. The non-transitory computer-readable medium of claim 17, wherein the processing resource is communicably linked with a datastore, wherein the datastore stores the entity intelligence database.
